(19) United States
(12) Patent Application Publication
(10) Pub. No.: US 2015/0128103 A1
(43) Pub. Date: May 7, 2015

(54) SYSTEM AND METHOD FOR AUTOMATING APPLICATION PROGRAMMING INTERFACE INTEGRATION

(71) Applicant: Runscope, Inc., San Francisco, CA (US)

(72) Inventors: Frank R. Stratton, San Francisco, CA (US); Stephen D. Huenneke, San Francisco, CA (US); John G. Sheehan, San Francisco, CA (US)

(21) Appl. No.: 14/536,200

(22) Filed: Nov. 7, 2014

Related U.S. Application Data
(60) Provisional application No. 61/901,258, filed on Nov. 7, 2013.

(51) Int. Cl. G06F 9/44

(52) U.S. Cl. CPC G06F 8/00
USPC 717/100

(57) ABSTRACT

A system and method for providing an application programming interface (API) service platform that includes configuring an API interaction sequence with a set of template requests and template variables; initializing execution of the API interaction sequence; and processing the API interaction sequence comprising, for each selected template request from a subset of the set of template requests: resolving a selected template request into a resolved request, comprising modifying fields of the template request with a template variable of the set of template variables; transmitting the resolved request; receiving a response to the resolved request; and setting at least one template variable based in part on the response.

### CROSS-REFERENCE TO RELATED APPLICATIONS

This application claims the benefit of U.S. Provisional Application Ser. No. 61/901,258, filed on Nov. 7, 2013, which is incorporated in its entirety by this reference.

### TECHNICAL FIELD

This invention relates generally to the application programming interface field (API), and more specifically to a new and useful system and method for automating API integration in the API field.

### BACKGROUND

Testing is an important part of the software development process. Many development tools exist for debugging and testing native applications. However, with the development of various software as a service (SaaS) and platform as a service (PaaS) offerings, more applications are dependent on outside systems. Many of these outside systems are accessed through an application programming interface (API). Integrating with outside systems introduces new complexities and issues that traditional debugging and testing tools cannot handle. Thus, there is a need in the API field to create a new and useful system and method for automating application programming interface integration. This invention provides such a new and useful system and method.

### BRIEF DESCRIPTION OF THE FIGURES

FIG. 1 is a schematic representation of a system of a preferred embodiment;

FIG. 2 is a schematic representation of a variation of the system used as an API proxy service;

FIGS. 3A-3E are schematic representations of an exemplary interfaces in configuring a test;

FIGS. 4A and 4B are schematic representations of an exemplary interfaces in reviewing test results;

FIG. 5 is a schematic representation of a method of a preferred embodiment;

FIG. 6 is a flowchart representation of processing an API interaction sequence;

FIG. 7 is a communication sequence diagram of a method of a preferred embodiment;

FIG. 8 is a communication sequence diagram of a method of a preferred embodiment;

FIG. 9 is a schematic representation of one variation of a set of configuration elements of an API interaction sequence;

FIG. 10 is a flowchart representation of setting initial context variables through a received API request;

FIG. 11 is a flowchart representation of executing scripts;

FIG. 12 is a flowchart representation of transmitting notifications;

FIGS. 13A and 13B are schematic representations of hosting a proxy server in a region distinct from a region of the API service platform;

FIG. 14 is a schematic representation of normalizing an API;

FIG. 15 is a communication sequence diagram of a method of a preferred embodiment;

FIG. 16 is an exemplary JSON object of an exported API interaction sequence; and

FIG. 17 is a schematic representation of an exemplary interface in adding scriptable elements to an API interaction sequence.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. System for Automating API Integration

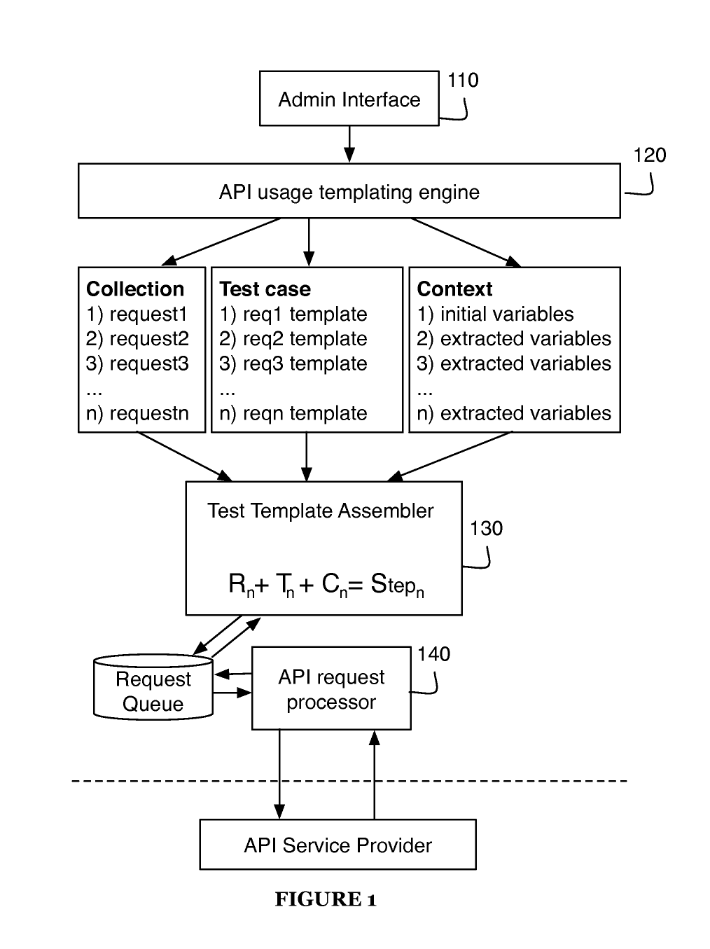

As shown in FIG. 1, a system for automating API integration of a preferred embodiment can include an API usage template interface 110, an API usage templating engine 120, a test template assembler 130, and an API request processor 140. The system functions to generalize API usage to a set of resources that are used in testing API usage, automating API usage, resolving API usage issues, and enabling other API interactions. The system is preferably configured by an administrator that facilitates defining API usage sequences (i.e., patterns of usage), templates, and testing parameters. When in an activated mode, the system applies the usage sequences, templates, and testing parameters to define API interactions.

The API tools can preferably be applied to any network accessible API. The API can be an internet accessible API provided by any suitable API provider, but can alternatively be an internal API such as a private/internal API with access restrictions (e.g., firewalls, IP blocklist, intranet connections, etc.). The API is more preferably accessed over an application layer protocol such as an HTTP-based protocol (HTTP or HTTPS), SPDY, other TCP/IP protocols, or any suitable networking protocol. Additionally, the system can be applied to API usage interactions involving two or more API service providers. The API service providers are preferably used by one or more API consumer entities. The API consumer entities can be an application or service utilizing the API to facilitate some portion of functionality.

The system is preferably configured for multitenant use by a plurality of different accounts (and respective administrators/users). Accordingly, the architecture of the system can preferably be scaled to change usage capacity. Similarly, the system can be regionally distributed to resolve latency issues when used by users of various locations. Regionally distributed computing resources can be used to provide geographic based testing. In some cases API calls may be impacted by latency or other geographic-based complications, and a set of regionally diverse computing resources can facilitate geographic testing. In another case, an API service may not be fully accessible over the public internet. The regionally distributed computing resources can include network-based computing resources to facilitate testing APIs available within secured network or network with limited access. Additionally, the multitenant property of the system can enable detection and identification of errors, events, suggestions, resolutions, and other forms of API request/response pattern detection across multiple accounts. API errors in one instance can be caused by mis-configuration of an API consumer. API errors in another instance may be caused by a change or fault in an API service. When similar API errors happen across API interaction sequences of multiple accounts, the system can detect API service error. Accordingly, the system can function to generate a notification distinguishing between API usage error (e.g., error of a consumer) and API service errors (e.g., error of the provider).

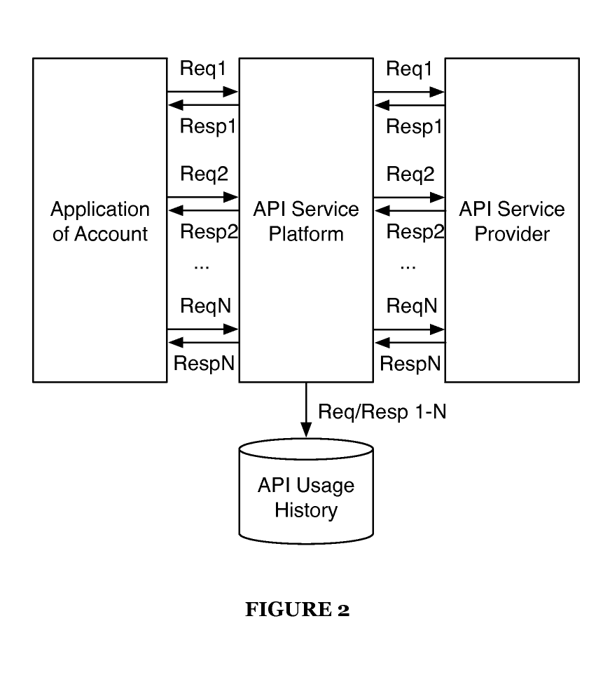

The system is preferably a cloud-hosted service implemented on a distributed computing infrastructure, a computing cluster, or any suitable computing system. The system can additionally be used as a proxy to outside API services. In place of an account holder sending API requests directly to an API service, the account holder sends API requests to the system and the system can then direct an appropriate response to the API service. The system can store a history and record of API requests and responses passed through the system as shown in FIG. 2. The API request/response history can facilitate generation of API interaction sequences. An API service provider can be any suitable service or software provider. The API service preferably interacts according to a service-defined protocol. An API service preferably interacts through a request and response communication flow.

In one preferred embodiment, the system is preferably applied to the testing and verification of API integration status. As an exemplary use of the system, a developer can set up commonly executed API usage for repeated testing. In running the API interaction sequences, different contexts can be quickly tested. The system can be used to determine if changes in the application have broken API integration, if changes in an API have broken integration with an application, if all or a portion of an API provider is suffering downtime, for rerunning common API operations, for normalizing API integration, and/or for any suitable automation or testing of an API. In an alternative embodiment, the programmatic integration and API sequence template engine may be applied to the translation between two different APIs. For example, the system may be applied to simplify the completion of a sequence of API calls to an outside service to select set of requests to the system. In another variation of the second embodiment, a request response sequence of a first API can be translated into a request response sequence of a second API, wherein the first and second API may be different APIs or different versions of the same API. This may be used in normalizing a set of distinct APIs so that a single normalized API can be used by a customer and the system automatically translates to one or more of the set of distinct APIs.

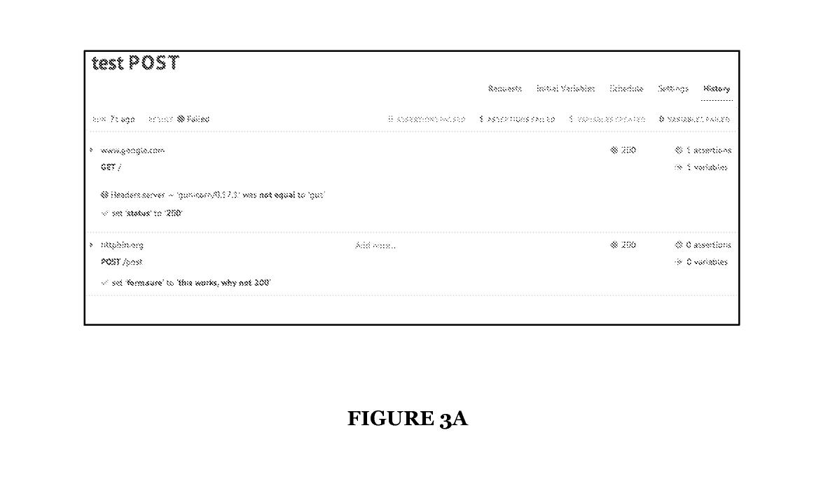

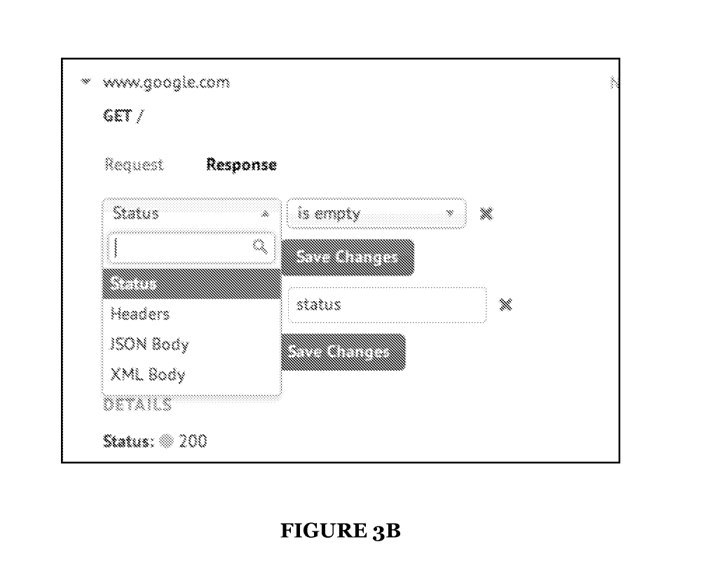

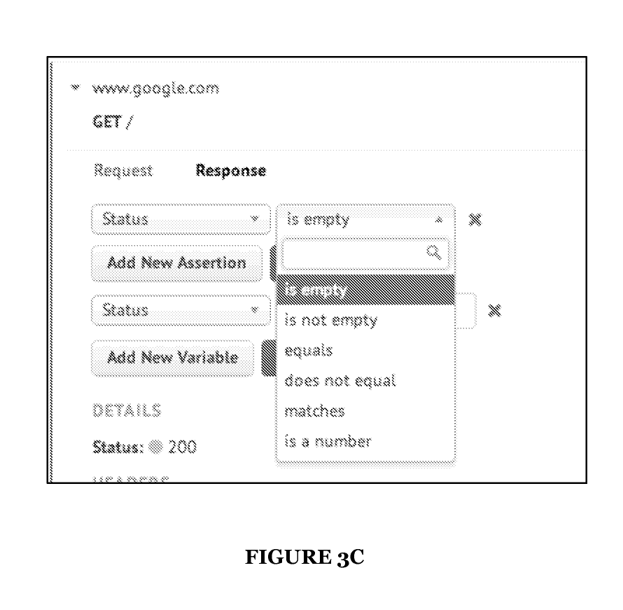

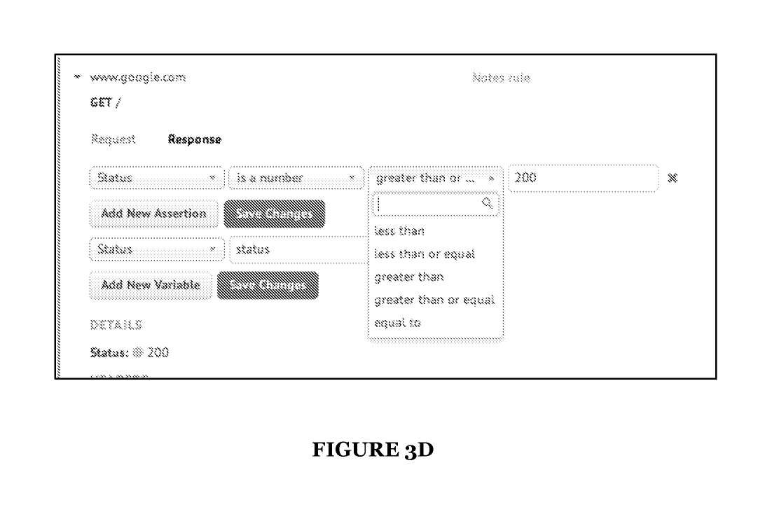

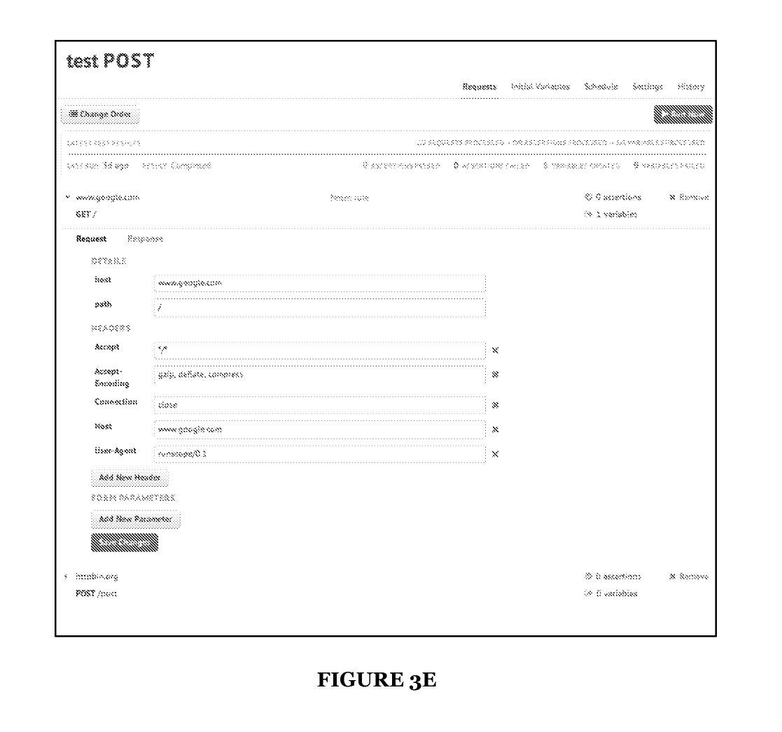

The API usage template interface 110 of a preferred embodiment functions to provide a mechanism for an administrator to configure and/or interact with configuration and/or results of templated tests. The API usage template interface 110 can be a graphical user interface. As mentioned above, the system is a multitenant system, and an account authentication layer can scope interactions made through the API usage template interface 110 to those of an associated account. The API usage template interface 110 is preferably a centralized portal through which a user can configure templates, initialize/schedule tests, and view results. An account holder or an administrator of an account preferably configures multiple API requests into a collection or set, templates how the set of API requests should be invoked, and configures test execution. API requests/responses can be organized into a sequence. The sequence can be a linear sequence, a conditional branching sequence of API requests/responses, or any suitably organized set of API requests/responses. The set of API requests/responses included in a collection or within a test is preferably displayed and are selectable for inspection as shown in FIG. 3A. The user interface can additionally include request/response inspection tools so that a request/response can be characterized according to how parameters are set for a request, what values should be asserted in a response, which information should be extracted into a variable and used in a subsequent request, and which should be replaced or modified according to a variable/context parameter.

Assertions can be set for various parameters of a request or response. In one exemplary implementation of an assertion interface, different parameter sources can be selected as shown in FIG. 3B, different conditions can be selected for a selected source as shown in FIG. 3C, and different values can be set for a condition as shown in FIG. 3D.

Parameters of a request or a response can additionally be inspected and templated to use extracted variables and other context variables as shown in FIG. 3E. Variable extractors can be defined which use information from an API interaction such as a request or response to set one variable. The variable may be used in filling in a template request. The variable may additionally or alternatively be used in a notification.

API usage template interface 110 can additionally include an API sequence script configuration, wherein one or more scripts can be configured for execution in association with an API interaction sequence. An API sequence script can be any suitable set of programmatic business logic and can be used in calculating template variables, context variables, completing assertions, interacting with additional services, or providing any suitable functionality. In one variation, an API sequence script is defined as an initial API sequence script. An initial API sequence script is executed before starting API communication of an API interaction sequence, which can facilitate setting initial context variables. In another variation, an API sequence script can be defined as a request API sequence script and is executed at some point in association with one request of the API sequence script. A request API sequence script can be executed upon receiving the response to a request and used in verifying an assertion or in setting a template variable.

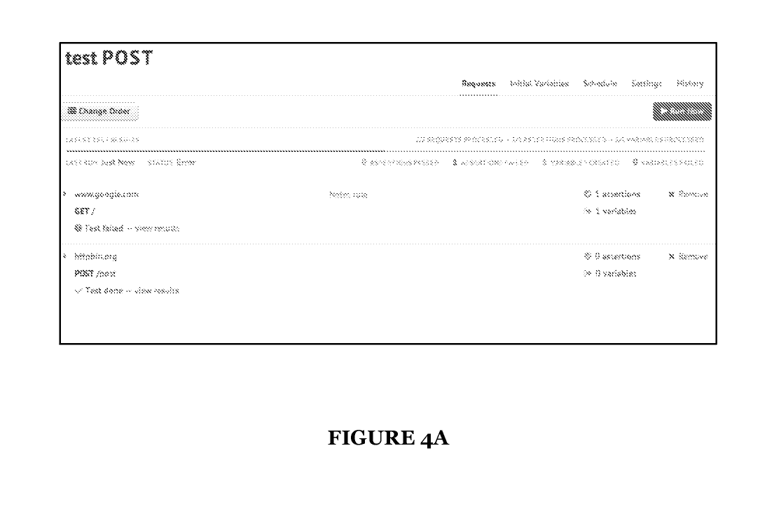

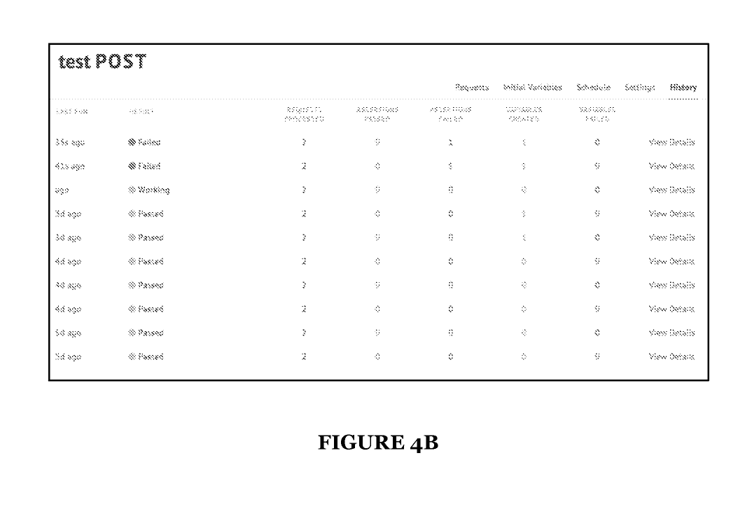

Additionally, API usage template interface 110 can include an interface that controls the timing of tests and trigger/initiate actions (e.g., sending notifications, making outgoing application requests/webhooks). Furthermore, the same interface can provide results of an executed test. The results can show assertion results, timing/latency of requests/responses of the sequence statistics across multiple tests, error or notification messages concerning test execution. In an exemplary implementation of a test result interface, the progress of a sequence of requests/responses can be displayed as shown in FIG. 4A. Tests can be run multiple times, and the history of results can be presented, explored, and/or inspected through the interface as shown in FIG. 4B.

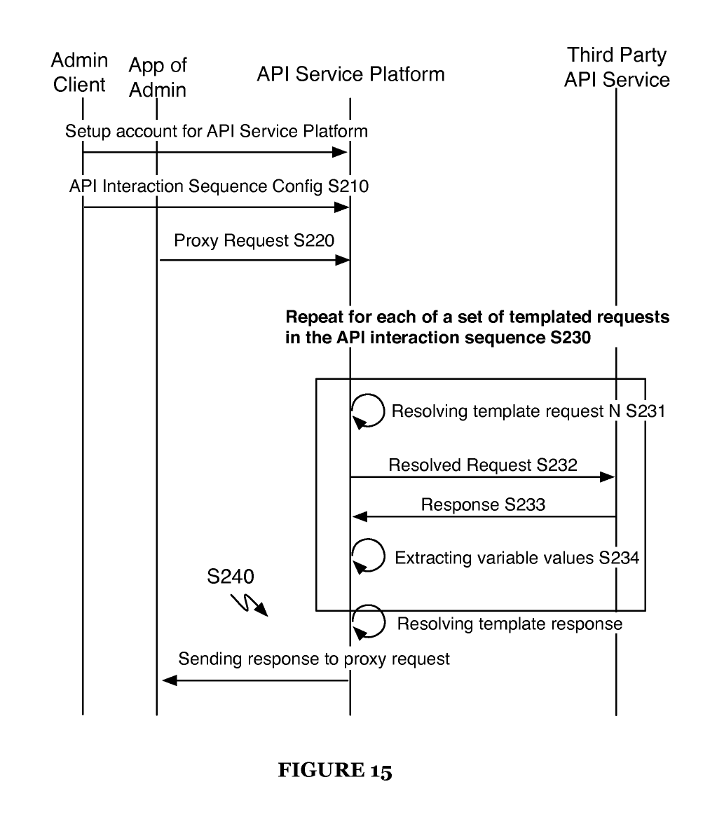

The API usage template interface 110 can alternatively or additionally include a programmatic interface. The capabilities of programmatic interface (e.g., an API to the system) can be substantially similar to a graphical user interface. The API usage template interface 110 can accept a configuration object that defines at least a portion of an API interaction sequence and associated components. The configuration object can be a file, a JSON file, an XML document, script of instruction, a collection of one or more types of files, or any suitable set of resources to define a portion of an API interaction sequence. In one variation, a configuration object can be exported from an existing API interaction sequence into a configuration object as shown in FIG. 15 A user could transmit the configuration object, copy configuration object, edit configuration object, combine the exported configuration object with other portions of configuration objects, commit it to version control, or use in any suitable manner. A configuration object can additionally be imported to programmatically generate an API interaction sequence.

The API usage templating engine 120 of a preferred embodiment functions to define data objects that can be used to construct and execute a templated test. Input obtained through the API usage template interface 110 described above can be used to instruct the construction of resources used in defining test execution. A test is preferably a set of templates based on a sequence of API requests and responses to be made/received with an API service provider. The test can be characterized by a collection data object, a template data object, and a context data object. The collection data object can define the base set of HTTP requests to be made and the order of the requests execution, and the template data objects can define how to modify the requests programmatically. The various resource components of a test can be used by the API request assembler to create dynamic requests.

The set of API requests are preferably made in a defined sequence, which can be defined by the collection data object. The sequence is preferably defined such that an initial request is made and the subsequent request is made after receiving an API response to the preceding request. An option to configure some or all requests to be made in parallel may alternatively be available. The collection data object is preferably constructed by identifying actual API requests made through the system. As described above, the system can additionally be used as an API service proxy wherein API communication from an application of an account holder is made through the system. As such, a history of actual API requests and responses is accessible and preferably stored in a storage system of the system. A subset of the actual API requests can be added to a collection data object, which functions to define full API requests without having to manually enter a request. The API requests can additionally be selected from a provided collection of sample API requests, edited, manually entered, or defined in any suitable manner. Additionally, the requests of the collection data object can be ordered. The order preferably defines the order the requests will be made during test execution.

The template data object functions to use content from API requests and responses. Template data objects can include placeholder variables that will be dynamically set according to the current context at the time of resolving the request. The placeholder variables are based on initial context variables or extracted variables. The template data object can also include extractors, which identify sections of a request/response to identify and assign to a variable. Simple values or parsed data from a request or response can be extracted. These can be set by assigning extractors to base requests or responses used from the collection. The template data object can additionally include request assertion properties. The assertion properties are conditions that can be tested and checked within a request. Assertion properties can define conditional value checks, type of values (e.g., a number, date, text, Boolean value, etc.), and/or any testable aspect of a request. The template data object can be sparsely defined and can depend on the base API requests/responses to generate a full message.

The context data object can define initial variable values and how variables are extracted from a request and/or response. The context data object can additionally include functionality to define a mechanism for processing and manipulating a variable.

In an alternative embodiment, the collection data object and the template data object may be combined, wherein in place of referring to a stored unmodified raw API request and a sparsely defined template file that overwrites the raw API request, a fully defined template of a request can be used.

Additionally or alternatively, at least a portion of a template data object can be request/response generation script, wherein the script is executed during API interaction sequence processing to generate a request. The script can use data from the current or previous state of the API interaction sequence. The script may additionally or alternatively interface with an outside service (e.g., accessing a third party API). A generation script can preferably generate multiple requests or responses. For example, in one variation, a first step of a API interaction sequence uses a static request template. The second step is a generation script that programmatically generates a request at the time of the second step. The script in this example may result in generating a sequence of 100 requests that iterate over an API parameter set to different values. When script ends request generation, the API interaction sequence may continue on to another statically defined request template.

The test template assembler 130 functions to process a test to determine at least the next API request to be made in the test. The test template assembler 130 uses the base request information from the next request as defined by the collection data object. The base request information is then updated according to the template data object and a current context. The current context is determined from context data object that is used to define how variable values are extracted from API requests and/or responses and define initial values. The output of the test template assembler 130 is preferably an API request (or response) that has been updated according to defined templating. The API request output of the test template assembler 130 is then transmitted to the API request processor 140. The test template assembler 130 can additionally include an assertion engine. The assertion engine can complete any assertions on requests and/or responses defined for a test. Assertion information and/or any suitable meta data around execution of a test can be integrated with the API usage interface to show the results of a test as shown in FIG. 4.

The API request processor 140 functions to transmit an API request and receive a response from an outside service. The API request processor 140 can be any suitable service worker or computing module. The response from an outside API service is preferably transmitted to the test template assembler 130, which will generate the next API request until the test is complete. The API request processor 140 can be a cloud hosted computing component, but the API request processor 140 may alternatively be an on-premise component. An on-premise component could be used where API usage is restricted to local on-premise infrastructure. More preferably, the system includes a set of API request processors 140, wherein the API request processors are part of the system's regionally distributed computing resources. A first subset of API request processors 140 can exist in a first region, and a second subset of the API request processors 140 can exist in a second region. Use of a particular region may be automatically set, but regional testing can be an API interaction sequence configuration option. For example, a user could configure a set of tests that test the execution of the same API sequence from various geographic regions. Any number of regions may be provided. The set of API request processors 140, which may be allocated or deallocated according to API interaction sequence demands.

The system can additionally include a notification engine, a scheduler, and API request processor 140. The notification engine can be used for integrating event based notifications and webhook interactions. The notifications can be emails, push notifications, SMS messages or any suitable alert. The notifications are preferably dependent on assertions, but may alternatively be dependent other properties of a test. The scheduler can cooperate with the test template assembler 130 to run a test at defined times. The scheduler can additionally enable different configuration of context data objects, such that different test instances can test different aspects. An API request processor 140 can be used to automatically detect a sequence of API requests associated with a new request and automating subsequent requests. Where a user may be required to make multiple requests to complete a task, a test (i.e., a templated sequence of API usage) can be automatically invoked and delivering the final result to the user.

### 2. Method for Automating API Integration

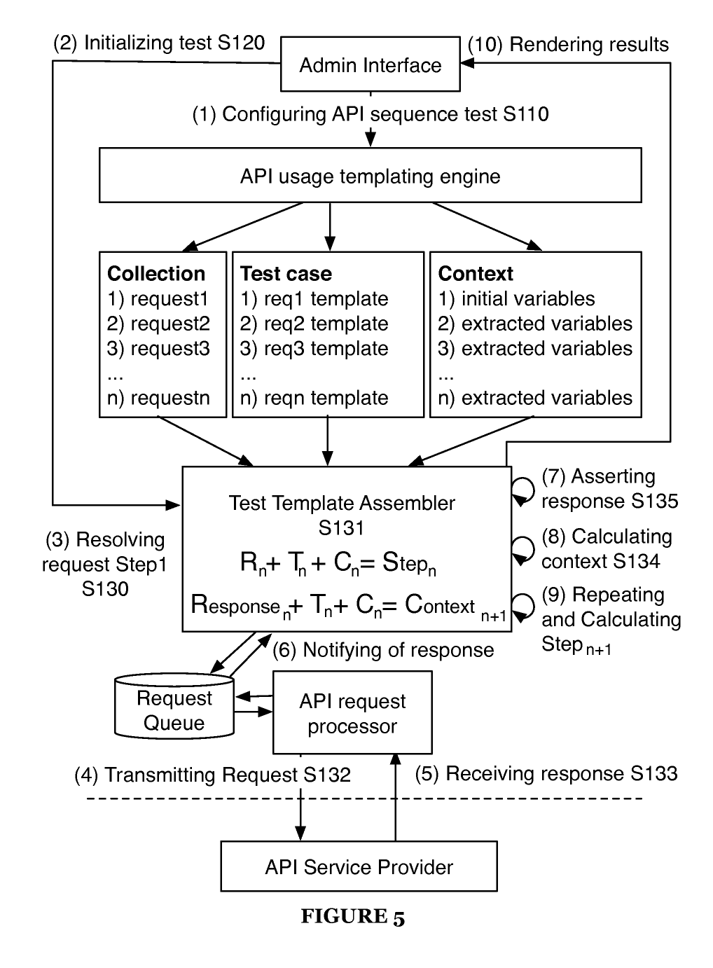

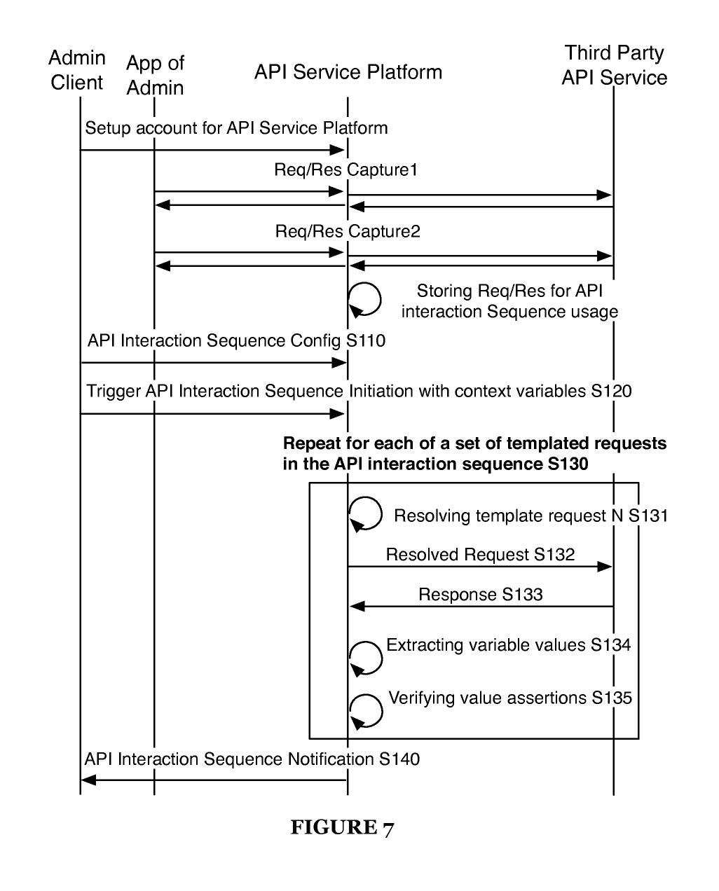

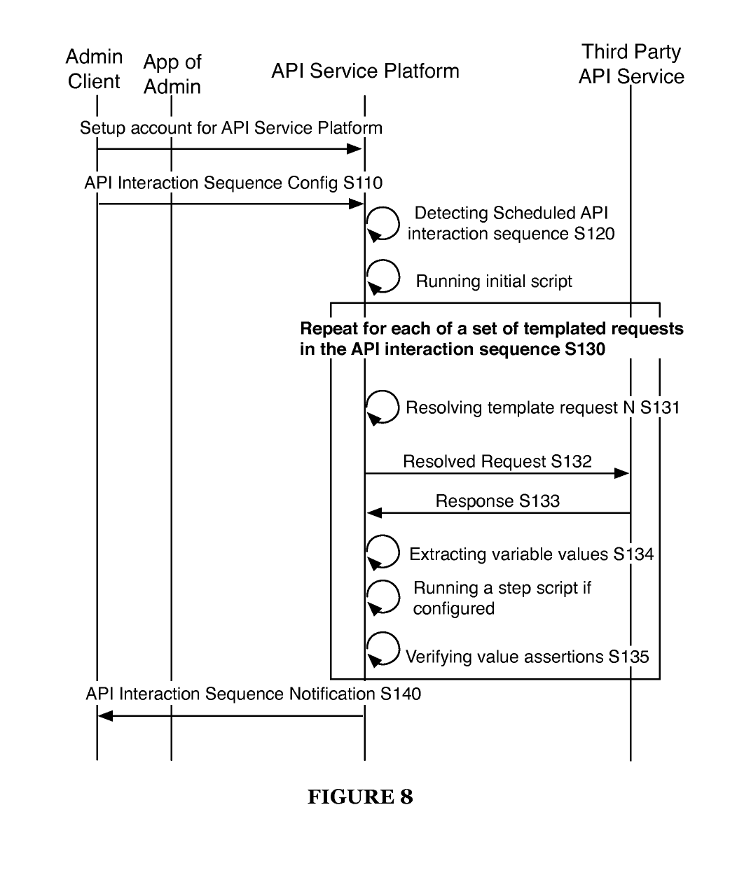

As shown in FIG. 5, a method for automating API integration of a preferred embodiment can include configuring an API interaction sequence with plurality of templated requests S110, initializing execution of the API interaction sequence S120, and processing the API interaction sequence S130. Processing the API interaction sequence S130 can include resolving a templated request into a resolved request S131, transmitting the resolved request S132, receiving a response to the resolved request S133, and setting at least one template variable S134. The method functions to enable automation of API interactions. API automations can be used in testing, monitoring status of used API services, debugging API integration issues, simplifying API interactions, and/or other suitable approaches. In a variation applied to testing and monitoring status of API integration, as shown in FIGS. 7 and 8, the Block S130 can further include verifying assertions S135. The method is preferably implemented by a system substantially similar to the one described above, but may alternatively be implemented or practiced by any suitable system. The method is preferably configured such that API testing is generalized and flexible to be applied to a wide variety of APIs as used by a variety of different applications/services. In an exemplary case of usage, a user can create an account on an API service platform (i.e., the method implementer), run API interactions through the API service platform, configure templates for a sequence of API interactions (which can be based on previously API interactions captured by the API service platform), and then execute a sequence of API interactions based on the templates. The executed sequence of API interactions can be dynamically set based on initialization, intermediary results of previous interactions in the API interaction sequence, scripting and integration with additional services, or other suitable factors.

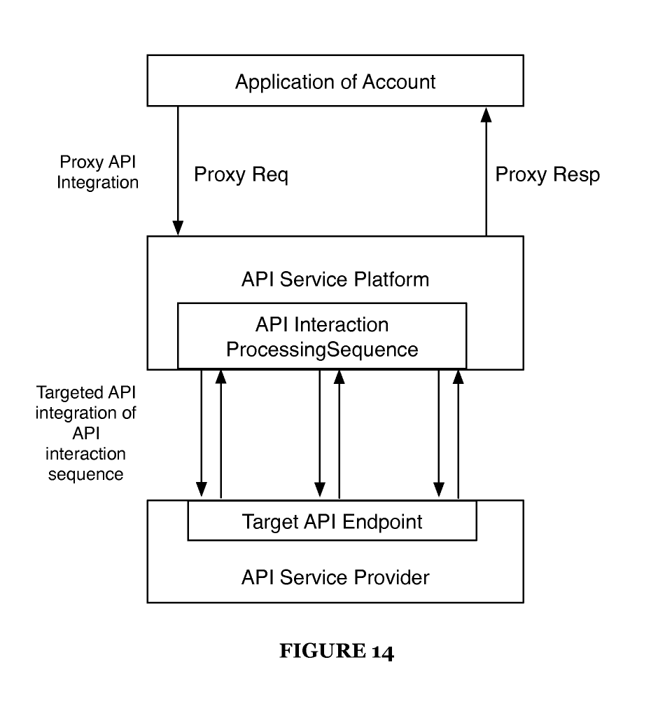

In one preferred embodiment the method is applied to API integration testing. The sequence can assert or test various conditions of the API interactions, measure performance of the API interaction execution, and/or send notifications about the API interactions. The executed API interactions are preferably performed as part of a test. Additionally or alternatively, the executed API interactions may alternatively be performed with the intent to deliver an end response to an initiating entity, which can function to simplify or normalize an API service as shown in FIGS. 14 and 15. Herein, use as a test will be described as the main application, but any suitable use of the automated API interaction can alternatively be used.

The method is preferably applied within a multitenant API service platform. The method can include creating a set of platform accounts, and, for each account in the set of platform accounts, creating at least one API interaction sequence configuration. As a multitenant platform, resources can be shared across multiple accounts when executing an API interaction sequence. For example, the server hosting a test template assembler module may be used for a first account and a second account. Similarly, the method is preferably customizable across a variety of API types. The method and similarly the system above may be particularly applicable to REST APIs. The processes of the method described herein can preferably be executed across multiple accounts and for multiple API interaction sequence configuration instances. The method can include processing the API sequence tests for multiple configurations of API sequence tests. Additionally, processing of the API sequence tests can occur in parallel with any suitable timing. Processing load balancing and queuing can similarly be used to balance API interaction sequence execution across multiple accounts.

The method is preferably used in testing or normalizing a RESTful API but may alternatively be used for any suitable API such as SOAP or a custom protocol. The RESTful API works according to an application layer request and response model. An application layer request and response model may use an HTTP-based protocol (HTTP or HTTPS), SPDY, or any suitable application layer protocol. Herein, HTTP may be used, but should not be interpreted as being limited to the HTTP protocol. HTTP requests (or any suitable request communication) to the communication platform preferably observe the principles of a RESTful design. RESTful is understood in this document to describe a Representational State Transfer architecture as is known in the art. The RESTful HTTP requests are preferably stateless, thus each message communicated contains all necessary information for processing the request and generating a response. The API service can include various resources, which act as endpoints that can act as a mechanism for specifying requested information or requesting particular actions. The resources can be expressed as URI's or resource paths. The RESTful API resources can additionally be responsive to different types of HTTP methods such as GET, Put, POST and/or DELETE.

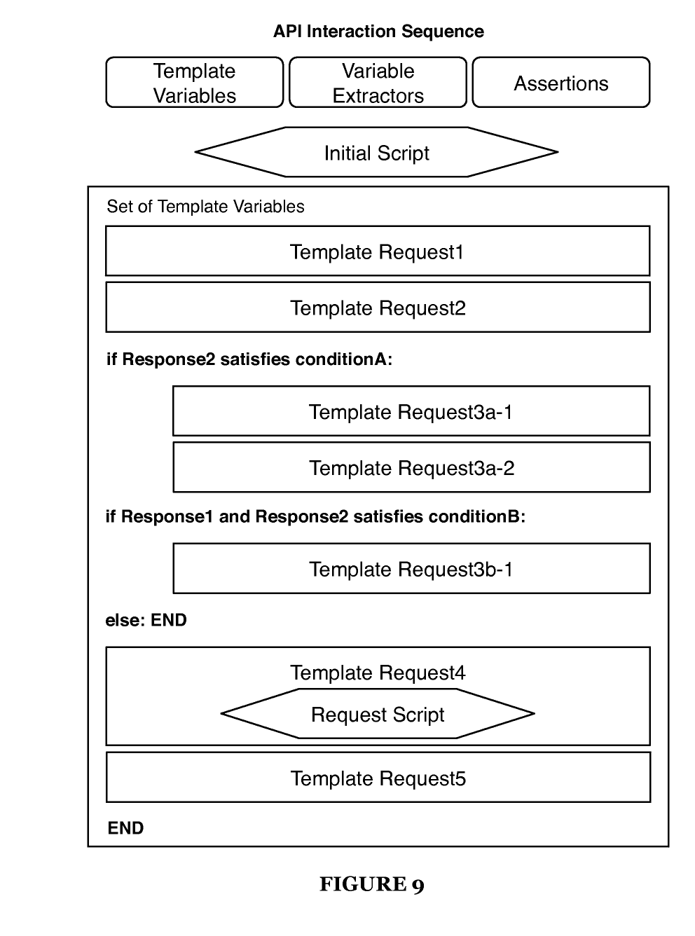

Block S110, which includes configuring an API interaction sequence with a plurality of templated requests, functions to set up resources to define the API requests communicated during a sequence of API interactions. An API interaction sequence is preferably setup as a configuration of an account in the API service platform. An account can preferably setup multiple API interaction sequences, which can have independent and varying configuration. In configuring an API interaction sequence, a defined or conditionally defined sequence of API interactions (e.g., requests or responses) are selected and modeled to determine how values should be asserted, extracted, and replaced as shown in FIG. 9. Configuring an API interaction sequence preferably includes configuring a set of template requests and a set of template variables. Additionally, API sequence scripts, variable assertions, notifications, and other aspects can be configured.

A templated request is an API request that has been configured to dynamically respond to execution. Any given request can depend on previous requests or pre-defined conditions/variables. Additionally, API interaction sequences can share common configuration settings. For example, configuring an API interaction sequence can include defining an API interaction sequence collection. An API interaction sequence collection is a group of API interactions that can be reused within other API interaction sequences, which functions to allow API interaction sequences to be nestable wherein one API interaction sequence can use part or all of a second API interaction sequence.

Configuring an API interaction sequence preferably includes receiving user input from an API interaction sequence editor. API interaction sequence configuration may alternatively be programmatically accomplished by using an API or any suitable interface. In one exemplary implementation, a list of API requests and accompanying request parameters displayed within a user interface. User interface elements can be presented to collect configuration of various aspects of the API interaction sequence.

Configuring an API interaction sequence can include defining API request template variables. A user can preferably specify where and how variables are inserted into or replace content in a request. A template variable is used as a placeholder that is updated with pre-defined context variable values of a test or based on variable values extracted from one or more prior API interactions is preferably used as the starting point and can be used to define the default values if a variable is not used to augment or replace content. A templating language or protocol can be used to specify the template variables within a request. Variables can additionally include default values if the variable value is not defined. Defining a template variable can include setting a default value, setting a variable extractor, setting a script to retrieve/calculate a value, or defining the value of the template variable in any suitable manner. A set of default variables may additionally or alternatively be provided for use within a request. A template variable can additionally be a function that operates on a value such as a random string function, a date formatting function, a hashing function, an encryption/signing function, a URL encoding function, or any suitable function. The template variables are additionally integrated into the API interaction sequence definition. Parameters of a given request can be edited to indicate what variable should be inserted where. Variables may be used in the API target endpoint (e.g., the URI where a API request is sent), the header parameters, the body parameters, or as any suitable parameter. An administrator configuring the API interaction sequence preferably initially defines a template variable. In one variation, a template variable can be marked by a variable name surrounded by double braces.

Defining a template variable can additionally include defining context variables. A context variable can be an initial variable value when starting the processing of an API interaction sequence. Pre-configured context variables are preferably used as test specific variables. In one implementation, they are the initial conditions that a test is configured for. Different instances of a test can be created with different context variables, which functions to apply the same API usage with the same template but with modified input variables. For example, a first test instance could be used to test an API sequence using a first API test server and a second test instance could be used to test an API sequence using a second API test server. In one implementation, a copy or new instance of an existing API interaction sequence can be generated within an account. The context variables can be edited to quickly update the new API interaction sequence instance for an appropriate use case.

Configuring an API interaction sequence can include defining API usage variable extractors. A variable extractor is used to define how values are extracted from an API interaction and assigned to a variable. If the same variable is used within a template, the extracted value assigned to a variable is inserted in the place of the template variable. The variable extractor can be used to extract values included in API responses from an API provider. Additionally, a variable extractor can include processing instructions. The processing instructions can allow an extracted value to be manipulated and augmented. For example, an extracted date value can be formatted into a second date format before being used in a placeholder template variable.

Configuring an API interaction sequence can include defining an assertion test. Assertions are conditional checks on properties of the API interactions. An assertion can be created on a request and/or a response from any set of API interactions. A conditional check on the value can be value type check (e.g., is the value a number, a date, text, etc.), value conditions (e.g., greater than, less than, equal relationships), pattern matching (e.g., regular expression match checks), or any suitable conditional check. An assertion preferably defines a property within an API communication (response or request) and the check on the corresponding value. More preferably, an assertion is defined by a source, a property, comparison, and target value. A source is the location of the data to extract for comparison. In an HTTP-based API protocol, data can be extracted from the HTTP header values and JSON, XML, text body content, or any suitable body section of one or more API requests/responses. An assertion may alternatively or additionally be based on an API response status code, time, size, and other properties. The property defines the property of the source data to retrieve. For HTTP headers this can be the name of the header. For XML and JSON content, the property can be JSON object property field. This may be an optional parameter and not used for basic sources such as text content, status codes, response time, and response size. The comparison is the type of operation when comparing the extracted data with a target value. Comparison types can include “is empty”, “is not empty”, “equals”, “does not equal”, “contains”, “does not contain”, “has key”, “has value”, “is a number”, “less than”, “less than or equal”, “greater than”, “greater than or equal”, “equals(number)”, and/or any suitable type of comparison. A script can similarly be defined that is computed and returns a result of an assertion. A target value is the expected value used to compare against the actual value. The target value can be a static value, or a variable-based value using the template syntax.

Configuring an API interaction sequence can include or be supplemented by capturing API requests. Captured API requests are preferably actual API requests and responses encountered by execution of an application. A user preferably configures a respective application or service to point API requests to an endpoint of the API service platform. The API service platform stores received requests, passes the requests on to a final API destination endpoint, receives responses from the final API destination endpoint, and stores the received responses. During an initial mode of operation, the API service platform monitors API usage and builds a repository of API requests. The source requests are transferred to the target API source and responses are similarly sent to the originating endpoint without translating or normalizing the API interactions. The monitored API requests can then be used in configuring an API interaction sequence, which functions to allow an administrator to quickly define API requests that include all the header and body parameters of regular requests.

More specifically, capturing API requests includes collecting a set of source API requests relayed through the API service platform and generating at least a subset of the template requests from the set of source API requests. Generating the subset of template requests can include setting a template request to include at least a subset of the API request parameters of the source API requests and with a destination API endpoint of a target API endpoint. For example, if an application is integrated with a social network API, the social network API requests are pointed to a URI of the API service platform. The API requests pointed to the API service platforms can be described as source requests. The API requests transmitted as a result of the API interaction sequence can be described as proxy requests—they are requests sent on behalf of the source requests. The proxy requests will preferably be communicated to the intended destination target URI of the social network API. The target API endpoint is preferably embedded in the source request. The method can include parsing the API request and determining a target API endpoint and API request parameters. In one variation, the target API endpoint is embedded in the URI endpoint of the API service platform. Any suitable syntax rules can be used to define how the target URI endpoint is embedded. For example, “https://api-yourapihere-com-<<key>>.example.com” can be used by an API service platform of example.com. The target API endpoint would have a domain of “api.yourapihere.com”. The request parameters are preferably those included in the header and body of the request. The source requests can include parameters to authenticate the requests. In the example above, a developer can include a key to authenticate the request. The method preferably generates a subset of the template requests from the set of source API.

The API service platform acts as a proxy when executing the API request on behalf of the application. The API interactions are preferably stored—requests and responses are logged for review. The stored API interactions can be used as a foundation to build a sequence of templated requests. Additionally or alternatively, base API requests can be edited by hand, loaded from a file, selected from sample or obtained through any suitable approach.

Configuring an API interaction sequence can include organizing API requests into collections, sets, or defined sequences of API requests. A user can select API requests to be used within a test, add them to a collection, and organize the sequencing of the API requests. The API requests preferably have a sequential order, but can alternatively include conditional branches to different API requests. For example, after receiving a response from a first response, a second request may be the next ordered request if a first condition is true and a second request may be the next ordered request if the first condition is not true. An interface preferably presents the set of API requests within the collection. The interface can further facilitate defining assertions, information extraction, and variable replacement. Multiple different tests (or more generally API interaction sequences) can be based on a single collection of API interactions.

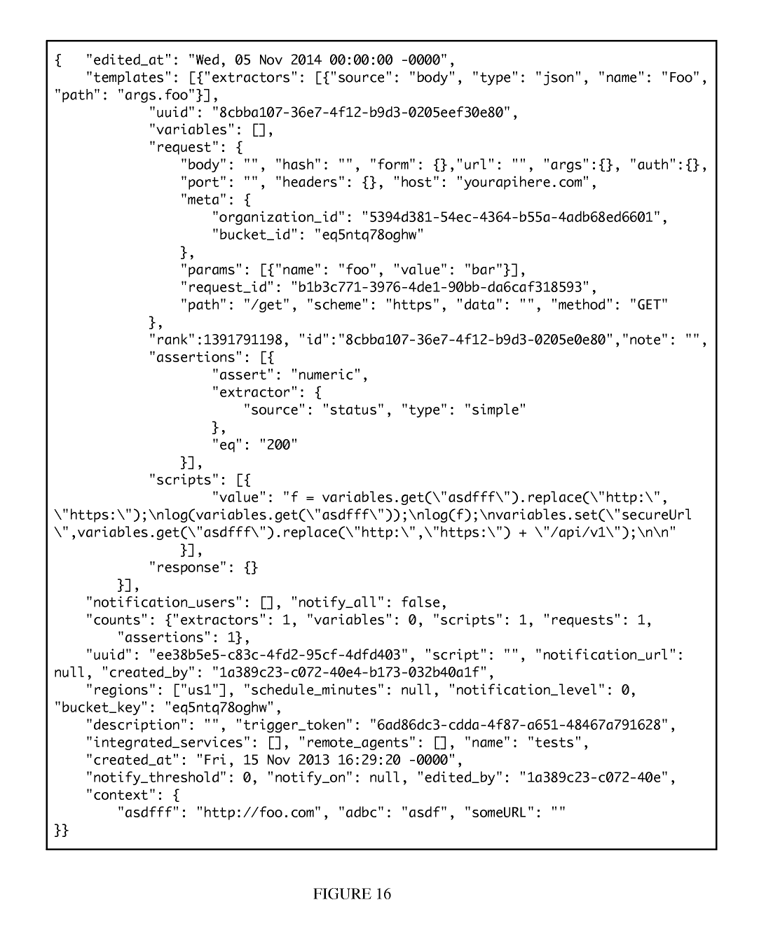

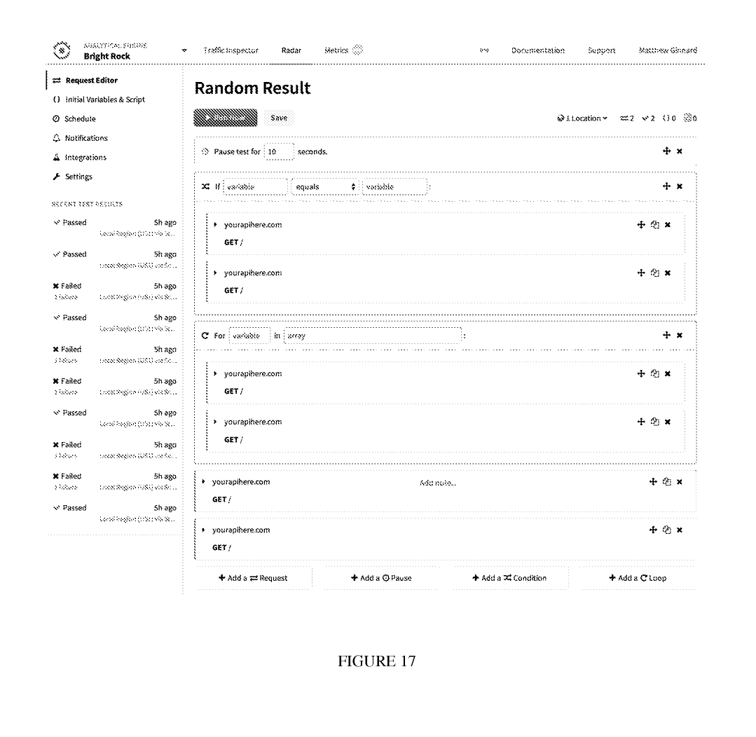

Configuring an API interaction sequence can include setting at least one API sequence script. Various aspects of the API interaction sequence can be scripted. A script can be configured for a variable extractor, an assertion test, an API interaction sequence initiation process (i.e., before resolving a template request), a step-associated process executed for a response to a given request, in processing an assertion scenario, in programmatically generating one or more request, as a non API interaction step. Scripting control mechanism can additionally be applied to the step processing of an API interaction sequence. In one variation, a scripting control mechanism can be used in looping over requests, performing conditional logic, executing a delay, executing a pause, spawning parallel API interaction sequence processes, or performing any suitable action. In a user interface a user may be enabled to select between adding a request template or a script block as shown in FIG. 16. In one instance variation, an API sequence script performs a calculation and returns a result. In another variation, an API sequence script may perform network interactions calling out to other services. In one alternative, in place of an API sequence script, an add-on integration component may be used. An add-on integration component is preferably a third party integration but can additionally be an optional, premium, or selectively enabled integration component. An add-on integration component preferably provides a set of different processing operations, and is preferably for a single outside service. In one implementation, an add-on integration component is a pre-defined API sequence step. The add-on integration component can include a configuration user interface to setup the options for using the add-on integration. For example, one add-on integration may allow a UI testing framework to be accessed, a login process completed, and a cookie or other suitable token retrieved from that interaction. That token can be set to a template variable, and used in later steps of the API interaction sequence. A marketplace of add-on integrations may be offered.

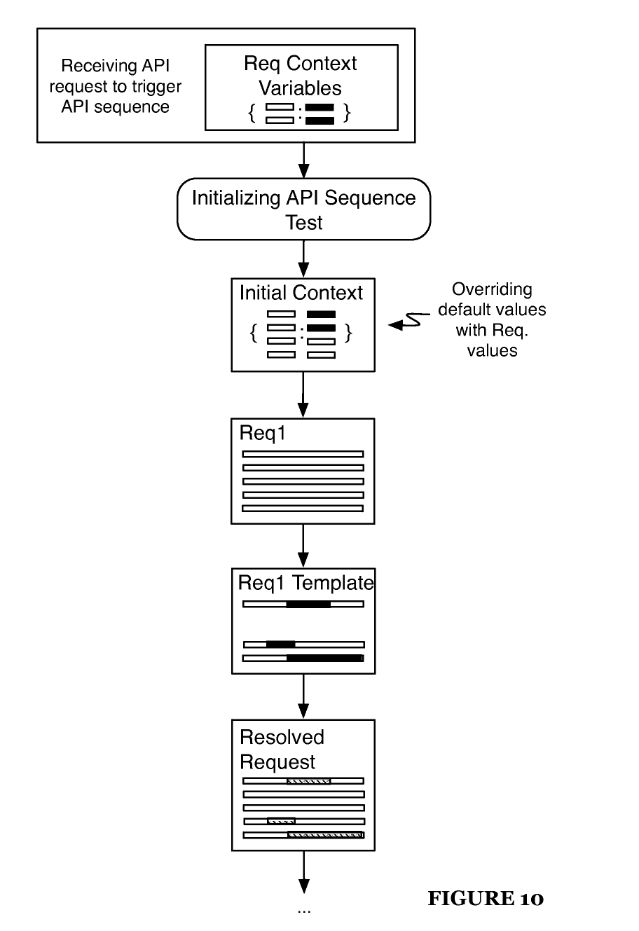

Block S120, which includes initializing execution of the API interaction sequence functions to start processing and communicating according to the configured API interaction sequence. Execution is preferably initialized through the user interface. A user can use a control panel to start the testing. As described below, real-time feedback on progress and information about the API interaction sequence can be presented while the test is executing. Execution can alternatively be initialized programmatically. For example, an API service platform can have an API that account holders can use to initialize and monitor API interaction sequences. Programmatic triggering of initialization can include receiving an outside request to trigger execution. The outside request preferably identifies the API interaction sequence to process, authenticates with account credentials, and may additionally specifies context at least one template variable value as shown in FIG. 10. The context template variable value is preferably used in setting a context template variable, which functions to allow an API interaction sequence to customized through meta data provided through an API request.

Initializing execution can additionally include detecting a scheduling condition for the API interaction sequence. Accordingly, Block S110 can additionally include configuring execution scheduling. Multiple tests can be planned and scheduled for different times. Additionally each test can be set with different initial context variables such that different variations of a test can be run. The tests can be reoccurring periodic tests, limited run tests, or single run tests. Additionally the execution can be conditionally invoked according to any suitable trigger.

In one variation, the API sequence is not used in a testing application but used in production to simplify integration of a first application with at least one API service. If a sequence of API interactions is commonly performed by an application, the application can use a configured API interaction sequence to automate access to the final end goal of an API interaction. As discussed above, an application can use an API service platform as a proxy to an API endpoint, and in one variation the method can include translating or normalizing API interactions. In such a variation, API requests passed through an API proxying platform can initialize execution of an API interaction sequence and respond with the end result (information from multiple responses). Accordingly, initializing execution of the API interaction sequence can include receiving a first API request that is configured with the API interaction sequence as a proxy. API interaction sequences can be dynamically invoked by detecting an API interaction pattern, by detecting a trigger parameter in a proxied API request, or through any suitable means.

In a manner similar to programmatically initiating an API interaction sequence, the method can include providing programmatic processing control of the API interaction sequence. An API or user interface may be enabled that provides the options of stepping through an API interaction sequence, running to a break point, pausing an API interaction sequence, delaying an API interaction sequence, resuming an API interaction sequence, augmenting configuration of the API interaction sequence during processing, or applying any suitable form of API interaction sequence processing control.

Block S130, which includes processing the API interaction sequence functions to execute the steps of the configured API interaction sequence. As described above, the API interaction sequence can define base requests and variables that augment the base requests. Value assertion, script execution, notifications, and other functionality can similarly be triggered while processing the API interaction sequence. In the case where an API interaction sequence includes a sequence of three API requests, the first template request is processed, then the second template request is processed, and finally the third template request. Each request is preferably processed upon receiving the response for the prior request. Block S130 can include resolving a templated request into a resolved request S131, transmitting the resolved request S132, receiving a response to the resolved request S133, and setting at least one template variable S134. Block S130 can further include verifying assertions S135.

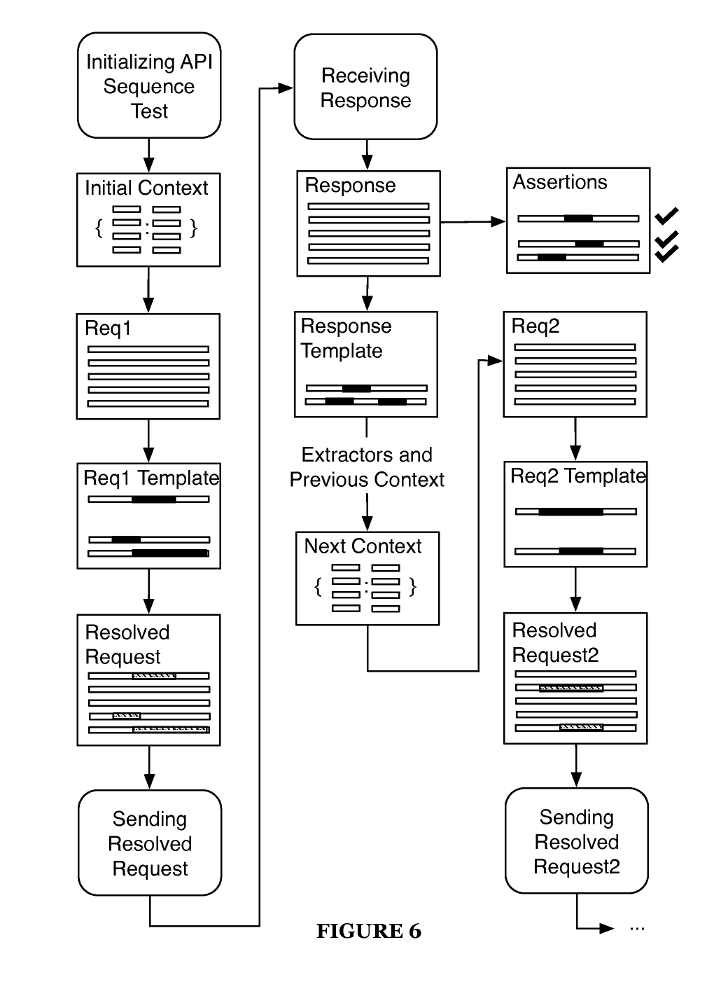

Block S131, which includes resolving a templated request into a resolved request functions to transform components of a configured API interaction sequence into actual requests. As shown in FIG. 6, a base API request (or other suitable interaction) is selected. The selected base API request is preferably the next API request in an ordered list of API requests. Configured variable extractors can additionally be invoked to identify properties of a request or response and assign a value of the property to a variable. The variable extractors are preferably used on API responses received in block S133. Then template variables are used to override or augment properties of the base API request. The template variables use context variables set as initial values or extracted from previous requests or responses. As discussed below an API interaction sequence preferably involves processing one request at a time. Block S131 can be performed repeatedly for each stage of a sequence of API interactions. In one variation, the API interaction sequence may dynamically determine the sequence of requests used. In the conditional sequence, Block S130 can include selecting template request for resolving and transmission. For the initial request, the first template request may be automatically selected. Alternatively, the initially selected template request may be conditionally selected based on the initial template variable values. After the processing the first template request, subsequent template requests may be selected based on previous requests, previous response, template variable values, script processing, or any suitable process. If the API interaction sequence comes to an end the processing terminates. Any subsequent processes such as notification, executing a proxy response, or any suitable action can occur.

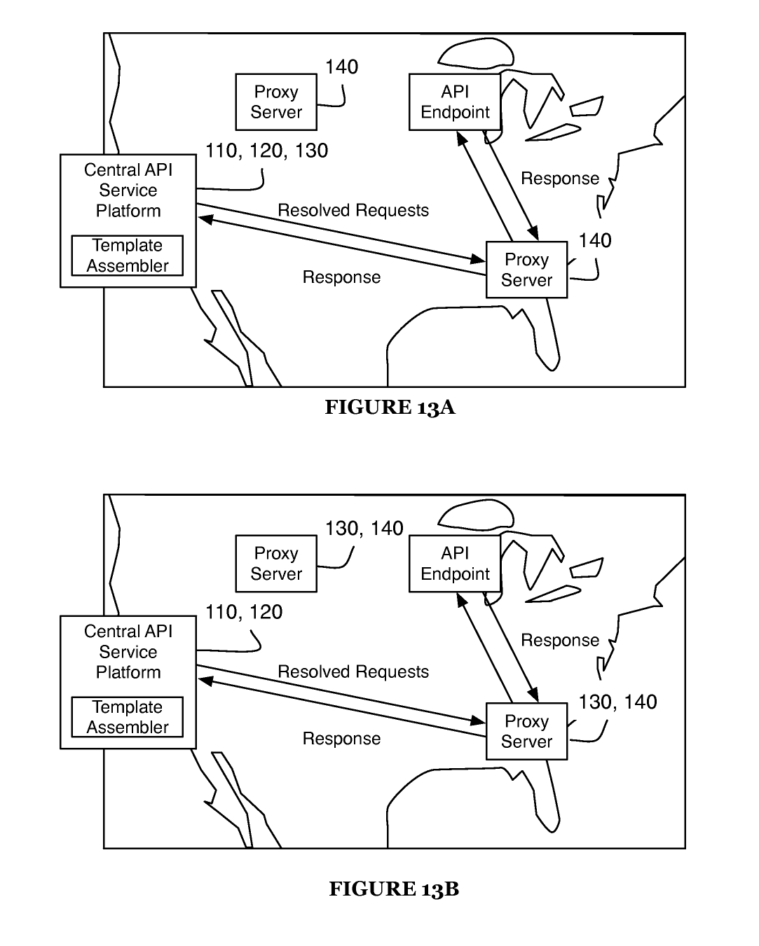

Block S132, which includes transmitting the resolved request functions to perform the API request. The API request is preferably sent to the intended API destination. The API request is preferably transmitted using a protocol of the intended API provider. For example, the API request can be sent over HTTP communication. When implemented by a multitenant API platform, the transmission of resolved requests can be managed through a queuing of requests. After a resolved request is formed, the resolved request (or alternatively a reference to the resolved request) is queued for transmission. A queue can be used to manage requests from a single account of multiple accounts. Queuing can enable resolved requests to be fairly attended. Additionally, a plurality of API request processors can be scaled independently from template assemblers and other components of the system. As mentioned above the API request processors are preferably located within a computing infrastructure of an API platform, but the API request processors can alternatively be installed and/or operated by a third party. The method can include hosting a proxy server in a region distinct from a region of a central API service platform. More preferably a set of proxy servers are hosted across a set of distinct regions. The regions may be distinct from a geographic standpoint (e.g., hosted on computing resources physically separated by more than one thousand miles) or from a networking standpoint (e.g., a proxy server hosted within a private network). In this variation, transmitting the resolved requests includes relaying the resolved request to the proxy server in the second region and transmitting the resolved request from the proxy server as shown in FIG. 13A. The response will additionally be received by the proxy server. In one variation, the response is relayed back for additional API interaction sequence processing. For example, an enterprise account holder may require the API requests to originate from within an internal network. In this variation, resolved requests are transmitted to an outside API request processor, which routes API requests and responses on behalf of the API sequencing system. The different stages of processing can alternatively be partitioned between regions in different manner. For example, resolving of a template request may occur at the proxy server or in a central region as shown in FIG. 13B.

Block S133, which includes receiving a response to the resolved request functions to receive an API response from an intended API provider destination. A response is preferably received for each API request transmitted. Though a one-to-one request-to-response relationship may not exist for each and every interaction. For example, a timeout can occur when waiting for a response or some protocols may enable real-time synchronous API interactions without a request and response model.

Block S134, which includes setting at least one template variable, functions to augment subsequently processed template requests. Variables of the API interaction sequence are preferably updated during processing of the API interaction sequence. More preferably, setting a template variable includes calculating a value of at least one template variable based at least in part on a response. Not every response may result in setting of a variable. Variables are preferably set according to variable extractors configured for the API interaction sequence. Each template request may include a different set of variable extractor settings. One request may have one variable extractor resulting in updating a single template variable, another request may have multiple variable extractors resulting in updating multiple variables, and yet another request may have no variable extractors and will not result in any modification of template variables.

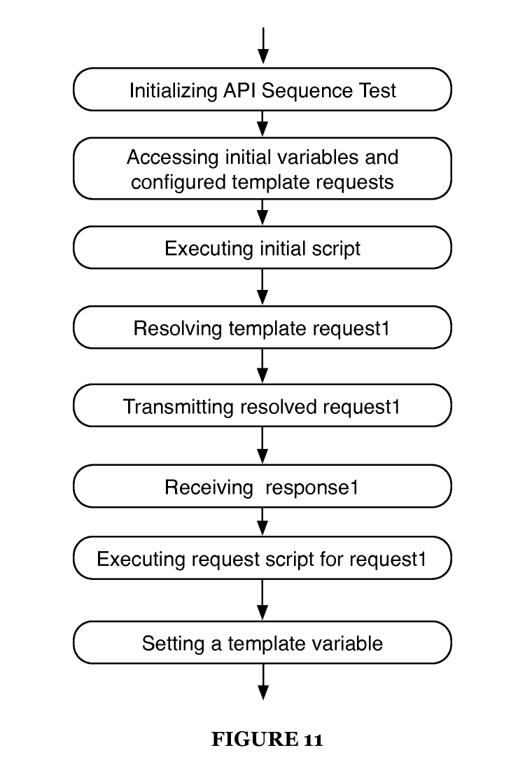

One variation may include executing a script in setting a template variable. The script can be customized logic to calculate a value for one or more template variables. A different script may be defined and executed for each of a set of template requests. In a variation including scripting, the method preferably includes defining at least one API interaction sequence script. An API interaction sequence script may be an initial script, an end script, or a step script (which will be associated with a particular request/response step) as shown in FIG. 11. Processing of the API interaction sequence will include executing a defined API interaction sequence script. The script is preferably processed upon receiving the response to the resolved request with which the script is associated. An initial API interaction sequence script may be processed prior to resolving a template request. An API interaction sequence script can be written in any suitable language or format. In one variation, JavaScript is used to write the script. The template variables can be available for use within the script, and may additionally be mutable—executing an API interaction sequence script can set at least one template variable. The script can enable more complicated variable extraction operations to be performed. A script may be basic calculations, but can additionally be able to call upon any external service or resources. For example, the script may perform a database lookup. The API interaction sequence script can additionally or alternatively be used in processing an assertion scenario.

Block S135, which includes verifying assertions, functions to apply conditional tests during the API interaction sequence. The assertions are preferably configured in S110. A configured condition of an assertion is checked, and an assertion invokes an error, a warning, or a passed flag. The assertion state is preferably logged. The request and response history of an executed API interaction sequence is preferably stored so that an administrator can review API interactions when an error or warning is generated. If an assertion is an error or warning, then notification or any suitable action can be triggered. The assertions are preferably performed on responses from an API provider but can similarly be performed on requests or other suitable API interactions. In addition to verifying assertions, the method can include monitoring, tracking, and/or measuring performance analytics of an executed API interaction sequence. Exemplary analytics can include API request/response timing metrics, IP location information, comparison of request performance relative to other requests, and other suitable properties of execution.

In one variation, the method can include for one targeted API service, detecting patterns in assertion errors across a set of accounts. In some cases, changes in an API service may cause widespread errors for API interaction sequences. Such error patterns may be automatically detected for a particular API. Such assertion errors may be classified or annotated to notify an administrator of the common error.

The method preferably involves the iteration of blocks S131, S132, S133, and S134 (i.e., API sequence processing blocks) as shown in FIG. 5. S135 may similarly be included in the interaction when processing the API interaction sequence. After a response is received, assertions are checked, variables are extracted to set a new context (i.e., current state of variables), and then the next base API request is selected and a resolved request is generated for the next base API request. As mentioned before can include selectively selecting a next API request based on a condition. The condition is preferably based on a value of a response variable, but can alternatively be based on timing of the test, context variables, or any suitable property.

While an API interaction sequence is processing, the method can include rendering API sequence progress and results. The progress information and results are preferably displayed in a control panel of an account such as on a webpage or in an application. Similarly, the progress information or results can be communicated to an outside endpoint such as to a command line interface. As shown in FIG. 4A, the interface can show progress of a test. Assertion results, progress in a sequence, and inspection of requests and responses are exemplary features provided in the interface.

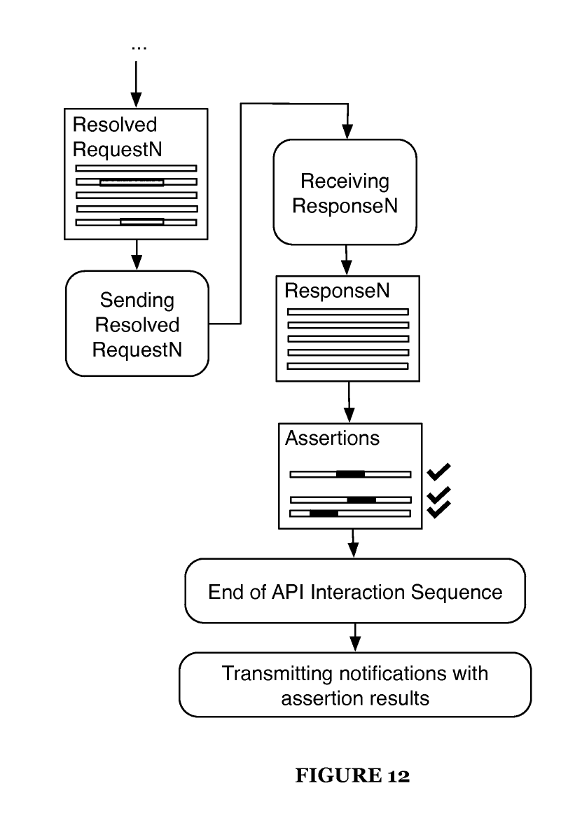

The method can additionally include executing notifications during processing of an API interaction sequence S140 as shown in FIG. 12. Configuring of an API interaction sequence can include setting a notification action. The notifications can be outbound communications such as email messages, SMS/MMS messages, application push notifications, phone calls, faxes, or any suitable communication. The communications are preferably set up for assertions, and more preferably for the case where an assertion fails. The method can include detecting a result of an assertion test and executing the notification action. In one exemplary implementation, a user can configure routine API interaction sequences to run every day to verify that API sequences used by an application are still compatible with one or more API service providers. When everything is operating normally, all assertions are verified. If an assertion fails, the assertion failure can result in executing a notification of an administrator so that the issue can be quickly resolved. Additionally or alternatively, the executed notification can be a programmatic notification. The programmatic notification can initialize sending an application layer protocol message to a URI as defined by the notification action, which can result in a second API sequence execution, making a single API request, or invoking a webhook notification. The webhook notification can post information about the associated event to an outside resource, and the outside resource can make any suitable response. A webhook is preferably pre-configured by an account administrator. A notification test can additionally include threshold preferences. A threshold preference can define the number of notifications sent, the rate of notifications sent, how notifications can be bundled into a digest of notifications, the conditions for notification (e.g., transitioning from success to failure or transitioning from failure to success), or any suitable sort of notification preference.

As described above, an alternative embodiment may apply the method to the normalization or other suitable translation of API interactions. As shown in FIG. 15, the method for translating an API can include configuring an API interaction sequence with a plurality of templated requests S210; initializing execution of the API interaction sequence in response to a first received proxy request from a first entity S220; processing the API interaction sequence S230 which includes resolving a templated request into a resolved request S231, transmitting the resolved request S232, receiving a response to the resolved request S233, and setting at least one template variable S234; and resolving and transmitting at least one proxy response to the first entity S240. The method functions to apply the API interaction sequence processing as a proxy to interacting directly with an API service. Blocks S210, S220, S230, S231, S232, S233, and S234 are preferably substantially similar to blocks S110, S120, S130, S131, S132, S133, S134 of the above method. Variations, alternatives and additional elements described above can additionally be integrated into the method for translating API interactions.

An API interaction sequence can be configured in a similar manner to above. The templating configuration can additionally map values between the proxy API interactions (sent from the first entity to the API service platform) and the template requests to be sent to the target API. The method additionally includes receiving an API proxy request, and the receipt of the API proxy request initializes processing of the API interaction sequence. The API proxy request is preferably sent from some entity such as an application or service. The received request is preferably mapped to an appropriate API interaction sequence. Variable extraction and initial template request resolution can initialize the API interaction request. A proxy response is generated during execution of the API interaction sequence or after completing processing of the API interaction sequence. There can be multiple proxy requests and proxy responses.

The method may be applied to normalize API interactions. By using the normalized API exposed by the API service platform, an account could selectively switch between different outside API services. A normalized API syntax can be used in talking to the API service platform, and the API interaction sequence is used in talking to a desired API service. The proxy API and the target API of the API interaction sequence can be different APIs—they can differ in type, in syntax, in endpoint, or any suitable property. In another variation, the proxy API and the target API are different versions of the same API. The proxy API can be a legacy or older version of the target API.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the API usage templating engine. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

What is claimed is:

1. A method for providing an application programming interface (API) service platform comprising:
configuring an API interaction sequence with a set of template requests and template variables;
initializing execution of the API interaction sequence; and
processing the API interaction sequence comprising, for each selected template request from a subset of the set of template requests:
resolving a selected template request into a resolved request, comprising modifying fields of the template request with a template variable of the set of template variables;
transmitting the resolved request;
receiving a response to the resolved request; and
setting at least one template variable based in part on the response.

2. The method of claim 1, wherein configuring the API interaction sequence with the set of template variables comprises defining at least one variable extractor; and wherein setting at least one template variable based in part on the response comprises calculating a value of at least one template variable from at least the response.

3. The method of claim 2, wherein configuring the API interaction sequence with the set of template variables comprises setting an initial value of a context variable in the set of template variables.

4. The method of claim 3, wherein initializing execution of the API interaction sequence comprises receiving an outside request to trigger execution of the API interaction sequence, the outside request including a set of context variable values; and wherein at least one context variable of the set of template variables is set through the outside request.

5. The method of claim 1, wherein processing at least a subset of template requests of the API interaction sequence comprises selecting a template request for resolving and transmission, wherein selecting the template request is conditionally based, at least in part, on the current state of processing the API interaction sequence.

6. The method of claim 1, further comprising collecting a set of source API requests relayed through the API service platform; and wherein configuring an API interaction sequence comprises generating at least a subset of the template requests from the set of source API requests.

7. The method of claim 6, wherein collecting a set of source API requests relayed through the API service platform comprises receiving a set of source API requests directed at the API service platform; parsing the API request and determining a target API endpoint and API request parameters; and wherein generating at least a subset of the template requests from the set of source API requests comprises setting a first template request to include at least a subset of the API request parameters of the source API requests and setting the first template request to have a destination API endpoint of the target API endpoint.

8. The method of claim 1, wherein configuring an API interaction sequence with a set of template requests and template variables comprises setting at least one assertion test for a first template request; and wherein processing at least a subset of template requests of the API interaction sequence further comprises verifying the assertion test in the response to the resolved request of the first template request.

9. The method of claim 8, further comprising hosting a proxy server in a region distinct from a region of the API service platform; and wherein transmitting the resolved request comprises transmitting the resolved request from the proxy server.

10. The method of claim 8, wherein configuring the API interaction sequence comprises defining at least one API interaction sequence script.

11. The method of claim 10, wherein the at least one API sequence script is associated with a first template request; and wherein processing the API interaction sequence comprises executing the at least one API interaction sequence script upon receiving the response to the resolved request that is associated with the first template request.

12. The method of claim 10, further comprising executing the at least one API interaction sequence script before resolving a template request.

13. The method of claim 10, wherein the API sequence script processes an assertion scenario.

14. The method of claim 10, wherein the API sequence script sets at least one template variable.

15. The method of claim 8, wherein configuring an API interaction sequence comprises setting a notification action; and further comprising detecting a result of the assertion test and executing the notification action.

16. The method of claim 15, wherein the notification action is sending an outbound message to a destination.

17. The method of claim 15, wherein the notification action is sending an application layer protocol message to a URI defined in the notification action.

18. The method of claim 1, further comprising resolving information from processing the API sequence into at least one proxy response; and transmitting the proxy response.

19. The method of claim 18, further comprising receiving an API proxy request from a first entity; wherein initializing execution of the API interaction sequence is in response to the API proxy request; and wherein the proxy response is transmitted to the first entity.

20. The method of claim 19, wherein the API proxy request is an API of a first service; and wherein processing the API interaction sequence transmits the resolved requests to an API of a second service.

21. The method of claim 19, wherein the API proxy request is a first version of an API of a first service; and wherein processing the API interaction sequence transmits the resolved requests to a second version of an API of the first service.
